(19) United States
(12) Patent Application Publication
(10) Pub. No.: US 2008/0257378 A1
(43) Pub. Date: Oct. 23, 2008

(54) LIGHTED FLOSSER SYSTEM

(76) Inventor: John M. Jansheski, Maryville, TN (US)

Correspondence Address: LUEDEKA, NEELY & GRAHAM, P.C., P O BOX 1871, KNOXVILLE, TN, 37901, US

(21) Appl. No.: 11/737,814

(22) Filed: Apr. 20, 2007

(51) Int. Cl. A61C 15/04

(52) U.S. Cl. 132/323; 362/109

(57) ABSTRACT

A flosser illumination system provides a flosser and an illumination device that is removably positionable on the flosser for illuminating the mouth during flossing.

### FIELD

This disclosure relates to the field of dental flossing devices. More particularly, this disclosure relates to the incorporation of a reusable lighting device for use with flossers, particularly disposable flossers.

### BACKGROUND

Disposable flossers are popular dental cleaning devices. The disclosure relates to improvements in the use of flossers, particularly disposable flossers, by providing a system which enables a reusable illumination device to be incorporated onto the flosser. The illumination device enables improved visibility during flossing without detracting from the disposability of the flosser.

### SUMMARY

The above and other needs are met by a reusable illumination system configured for use with a disposable flosser.

In a preferred embodiment, the illumination system includes a housing which contains an electronic circuit having an illumination source for being illuminated. The housing is configured to be removably positioned on the flosser to direct light from the illumination source toward a desired location.

The illumination system may also be utilized with other disposable dental tools, such as picks, scrapers, interdental brushes, and the like to provide lighted dental care systems.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIGS. 1-4 show a lighted flosser system according to an embodiment of the disclosure.

FIG. 5 shows a lighted flosser system according to an alternate embodiment of the disclosure.

FIG. 6 shows a flosser for use with system of FIG. 5.

FIG. 7 is a cross-sectional side view of the system of FIG. 5.

FIG. 8 is a cross-sectional side view of the flosser of FIG. 6.

FIG. 9 shows a lighted flosser system according to yet another embodiment of the disclosure.

FIG. 10 shows a flosser for use with system of FIG. 9.

FIG. 11 is a cross-sectional side view of the system of FIG. 9.

FIG. 12 is a cross-sectional side view of the flosser of FIG. 10.

FIG. 13 shows a lighted flosser system according to a further embodiment of the disclosure.

FIG. 14 shows a flosser for use with system of FIG. 13.

FIG. 15 is a cross-sectional side view of the system of FIG. 13.

FIG. 16 is a cross-sectional side view of the flosser of FIG. 14.

### DETAILED DESCRIPTION

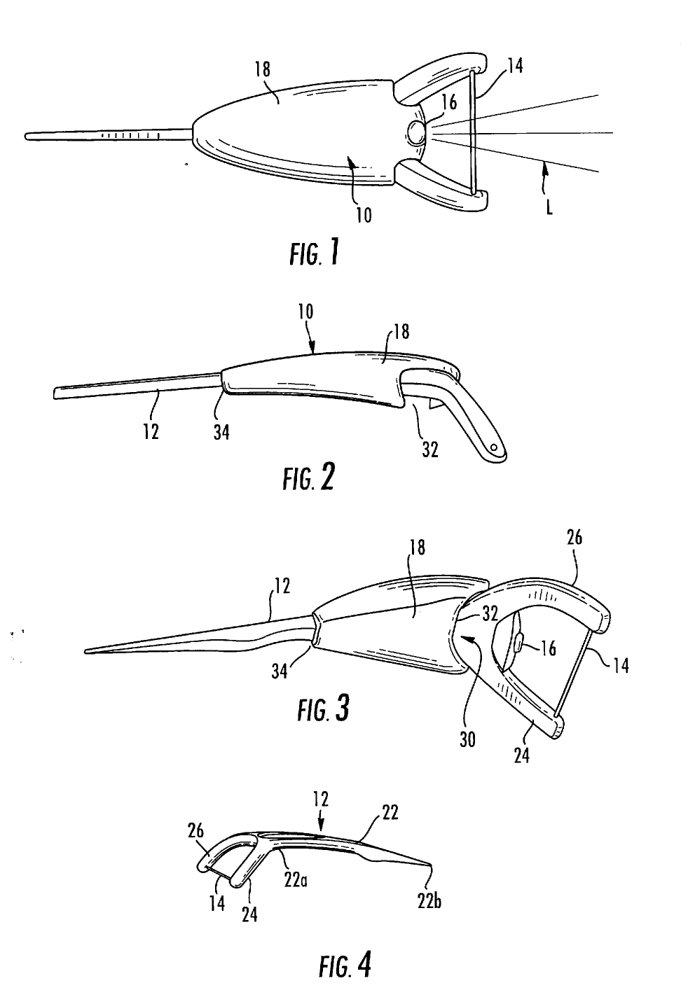

With initial reference to FIGS. 1-4, the disclosure relates to a lighted flosser system having a reusable illumination system 10 configured for use with a flosser 12 having floss 14. While the system is described in connection with flossers, it will be understood that the system may also be incorporated onto other dental tools, such as picks, tongue cleaners, interdental brushes, and the like, particularly disposable versions of such devices.

The illumination system 10 includes an illumination source 16, such as a light emitting diode, configured to direct light to the floss 14, as indicated by arrow L, to illuminate and enhance visibility of the floss 14 at sites of interest. The illumination system 10 is provided as by a plastic housing 18 configured to slide over a portion of the flosser 12 and snap-fit or friction fit onto the flosser 12 for use, as described in more detail below.

A preferred flosser 12 is a plastic disposable flosser available under the name EASY ANGLE from DenTek Oral Care, Inc. of Maryville, Tenn. Such a flosser 12 is described herein and includes a handle 22 and a pair of arms 24 and 26 extending from a distal end 22a of the handle 22. The floss 14 extends between the arms 24 and 26. The handle 22 of the flosser 12 has a length of about 2 inches and a decreasing taper from the distal end 22a to a proximal end 22b, which may serve as a pick when removed from the handle 10.

As mentioned above, the housing 18 of the illumination system 10 is configured to slide over a portion of the flosser 12 and snap-fit or friction fit onto the flosser 12 for use. In this regard, the housing 18 is configured as a sleeve to define an interior channel 30 that extends between opposite open ends 32 and 34. The end 32 is configured to snap fit over the distal end 22a of the handle 22 of the flosser 12, including portions of the arms 24 and 26 of the flosser 12.

In this regard, the illumination source 16 is located on the housing 18 so as to be located between the distal end 22a of the flosser 12 and the floss 14 when the illumination system 10 is installed on the flosser 12. This facilitates the direction of the light onto the floss 14 as shown. The housing 18 and the channel 30 taper from the end 32 to the end 34 such that the end 34 is substantially narrower and closely fits the relatively narrow shape of the handle 22 of the flosser 12 when the illumination device 10 is installed on the flosser 12.

A simple self-contained electrical circuit, including a battery, wiring, and a switch for operation of the illumination source 16, is incorporated into the housing 18 in a conventional manner of incorporating a light circuit into a body. For example, the housing may be made of injection molded plastic and the battery, wiring, switch, and the illumination source 16 incorporated during the molding process. The switch may be a simple on/off pressure switch located at the surface of the housing 18 for convenient access by a user.

To install the illumination device 10 onto the flosser 12, the proximal end 22b of the handle 22 is inserted into the open end 32 and passed through the channel 30 until the open end 32 is adjacent the distal end 22a of the flosser 12. The open end 32 is then pressed against the flosser 12 to snap fit over the distal end 22a of the handle 22 of the flosser 12, including portions of the arms 24 and 26 of the flosser 12, as shown. The illumination device 10 may be readily removed in a similar manner. In this manner, the device 10 may be reused many times.

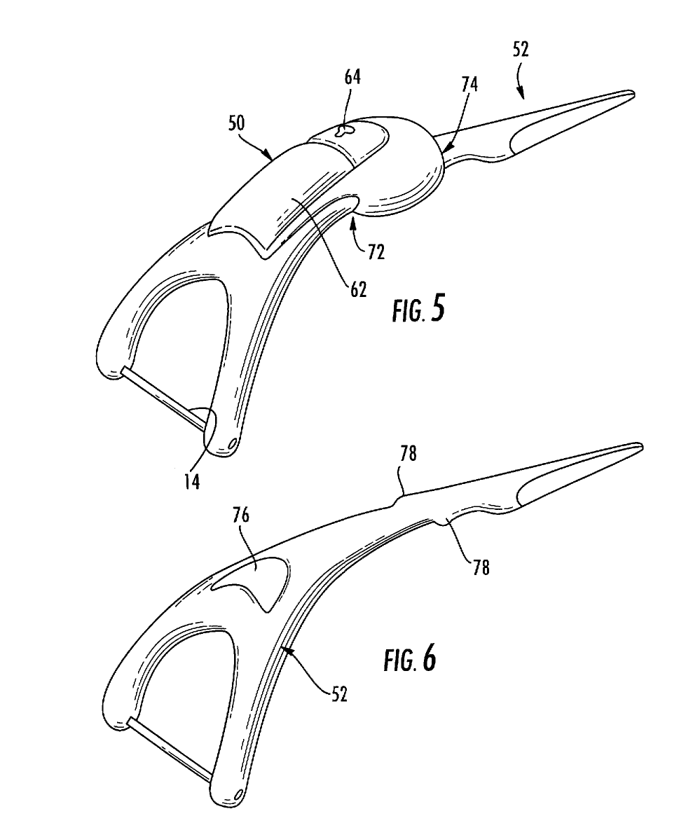

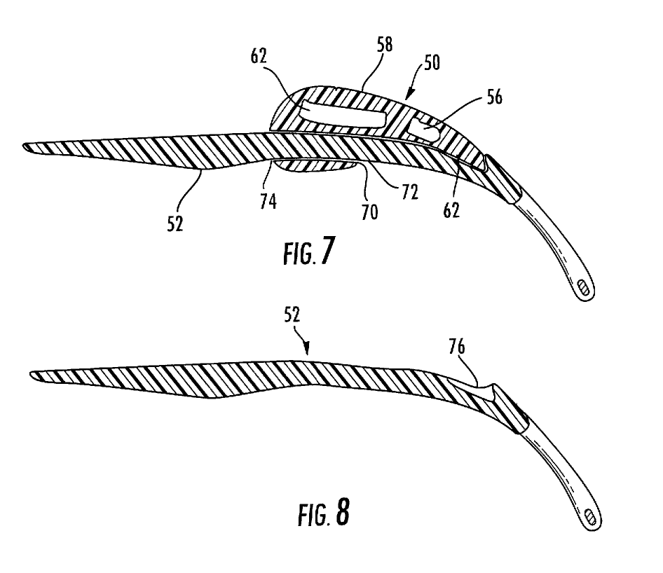

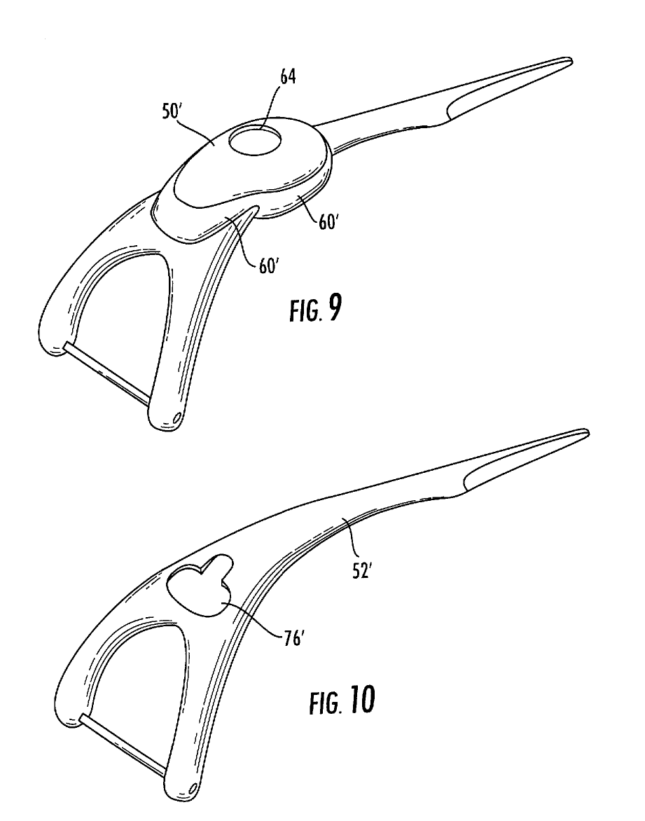

With reference to FIGS. 5-8, there is a lighted flosser system having a reusable illumination system 50 configured for use with a flosser 52. The system 50 includes an illumination source 56, such as a light emitting diode. The illumination system 50 is provided as by a plastic housing 58 configured to slide over a portion of the flosser 52 and snap-fit or friction fit onto the flosser 52.

The housing 58 is preferably made of injection molded plastic and includes a transparent area 60 made of a substantially light-transparent plastic. In this regard, the housing 58 includes a simple electronic circuit including a battery 62, a switch 64, the illumination source 56, and associated wiring. The illumination source 56 is preferably imbedded within the transparent area 60 of the housing 58.

The housing 58 is configured as a sleeve to define an interior channel 70 that extends between opposite open ends 72 and 74. The transparent area 60 preferably extends beyond the channel 70 for enhanced illumination effects. The flosser 52 is preferably made of a clear or substantially light transparent plastic material and configured similar to the flosser 12. The flosser 52 is further configured to include a front recess 76 for abutting the front edge of the transparent area 60 of the housing 58 and protrusions 78 for engaging the channel 70 for providing a friction fit between the housing 58 and the flosser 52. The illumination system 50 may be installed onto the flosser 52 in a manner similar to that described for the system 10 and the flosser 12.

As will be noted, light emanates from the transparent area 60 of the housing 58. The travel of light toward the floss on the flosser 52 is enhanced by providing at least the arms of a clear or substantially light transparent material.

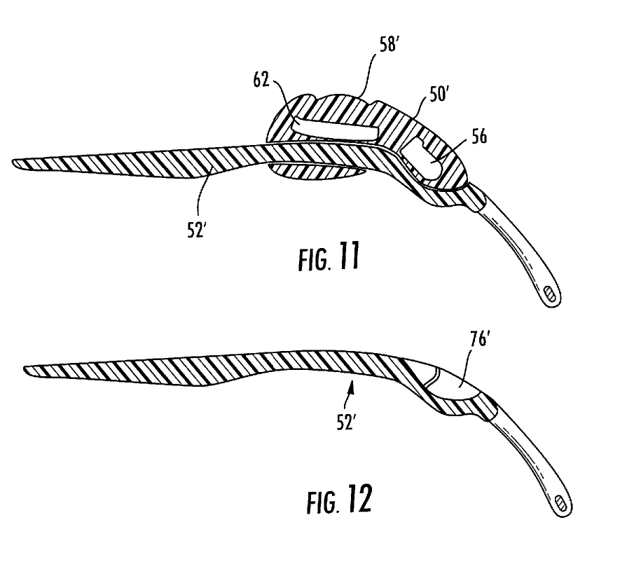

With reference to FIGS. 9-12, there is shown a lighted flosser system having a reusable illumination system 50′ configured for use with a flosser 52′. The system 50′ is substantially identical to the system 50, except for the shape of a transparent area 60′ of its housing 58′ which corresponds to the transparent area 60 of the housing 58. The transparent area 60′ is provided adjacent only a lower section of the system 50′ as shown. Likewise, the flosser 52′ is substantially identical to the flosser 52, except it includes a front recess 76′ configured for fittingly engaging a lower surface of the transparent area 60′.

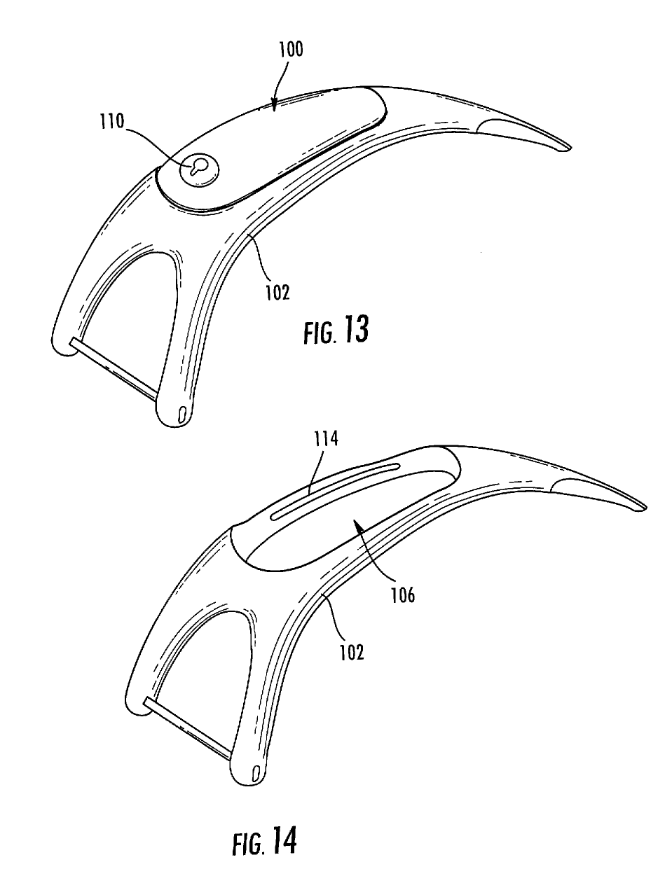

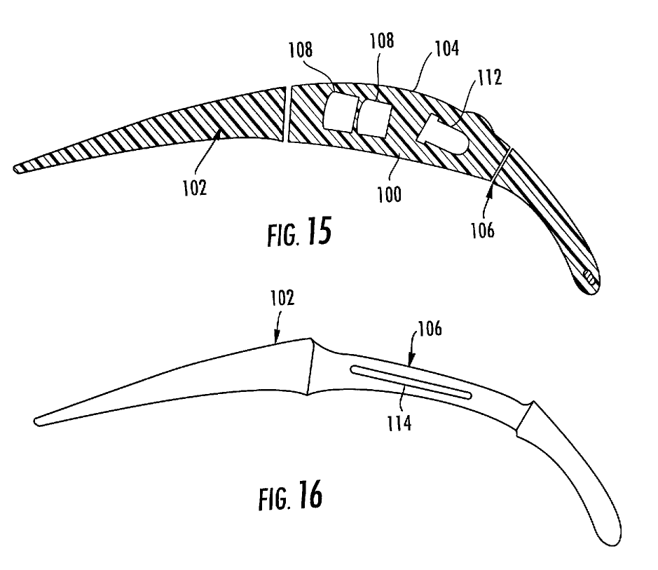

With reference to FIGS. 13-16, there is shown an alternate embodiment of a lighted flosser system having a reusable illumination system 100 having a flosser 102. The system 100 is provided as by a plastic housing 104 configured to be snap-fit or friction fit into a receiver 106 defined on the flosser 52.

The housing 104 is preferably made of injection molded plastic and at least a portion thereof adjacent an illumination source is made of a clear or substantially light-transparent plastic. The housing 104 includes a simple electronic circuit including one or more batteries 108, a switch 110, an illumination source 112, and associated wiring. The illumination source 112 is preferably positioned within the housing 104 so as to direct light directly towards the arms of the flosser when the housing 104 is installed.

The housing 104 is generally ovalized so as to fit within the generally oval shape of the receiver 106. Detents 114 along the sidewalls of the receiver 106 frictionally engage the housing 104 or additional corresponding contacts structure on the housing, such as grooves or the like, to retain the housing 104 within the receiver 106. Thus, the housing 104 may be easily installed within the receiver 106 for use, and then easily removed by depressing to disengage from friction fit.

The flosser 102 is preferably made of a clear or substantially light transparent plastic material. In this regard, the housing 104 is positioned within the receiver 106 so that the illumination source 112 is directly adjacent the arms of the flosser 102 so as to direct light directly towards the arms of the flosser when the housing 104 is installed. This is preferred for using the floss. However, if desired, the housing 104 may be reversed 180 degrees so that the illumination source 112 is adjacent the proximal end 22b or pick end of the flosser. This is preferred when using the pick end. Also, it will be understood that multiple illumination sources may be included so as to light both the floss and the pick end without having to reorient the housing.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A reusable illumination system configured for use with a disposable flosser, the illumination system comprising: a housing including an electronic circuit having an illumination source for being illuminated, the housing being configured to be removably positioned on the flosser to direct light from the illumination source toward a desired location.

2. The illumination system of claim 1, wherein the housing is configured to slide over a portion of the flosser.

3. The illumination system of claim 1, wherein the housing is configured to snap onto a portion of the flosser.

4. The illumination system of claim 1, wherein the flosser includes a receiver and the housing is configured to be received by the receiver.

5. The illumination system of claim 1, wherein at least abutting portions of the flosser and the housing are clear or substantially light transparent.

6. A lighted dental care system, comprising: a disposable dental tool and a reusable illumination system removably positionable on the dental tool, the illumination system including a housing having a self-contained electronic circuit comprising a battery and an illumination source for being illuminated, the housing being configured to be removably positioned on the dental tool to direct light from the illumination source toward a desired location.
